(19) United States
(12) Patent Application Publication
(10) Pub. No.: US 2002/0136190 A1
(43) Pub. Date: Sep. 26, 2002

(54) Band-division demodulation method and OFDM receiver

(76) Inventor: Yoshiyuki Hata, Tokyo (JP)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/003,259

(22) Filed: Dec. 6, 2001

(30) Foreign Application Priority Data
Mar. 26, 2001 (JP) P. 2001-087278

(51) Int. Cl. H04J 1/00

(52) U.S. Cl. 370/344; 370/480

(57) ABSTRACT

The present invention provides a band-division demodulation method and an OFDM receiver in which, by equalizing the characteristics of band-pass filters for parallel processing by band division, the development costs of the band-pass filters can be relieved and it can be constructed economically. They are the band-division demodulation method and the OFDM receiver in which an RF signal is in-phase-distributed in an in-phase distributor into a band division number, in local oscillators and a frequency conversion section, the band width that the entire band width of the received RF signal is divided by the band division number is used as a unit band width, and each signal distributed so as to be shifted stepwise by integral times of the unit band width is frequency-converted, and each signal frequency-converted is allowed in BPF to band-pass with the same characteristics, and then OFDM-demodulated in an OFDM demodulation section.

### BACKGROUND OF THE INVENTION

(i) Field of the Invention

The present invention relates to receivers in OFDM (Orthogonal Frequency Division Multiple) communication mode of multi-carrier CDMA transmission system used in high-speed wireless LANs or the like, particularly to OFDM receivers capable of decreasing the kinds of BPF, relieving the development costs of BPF, and being constructed economically.

(ii) Description of the Related Art

OFDM (Orthogonal Frequency Division Multiple) system being used for European ground-wave digital broadcasting is a modulation/demodulation system in which several thousands carrier waves processed by QAM (Quadrature Amplitude Modulation) or QPSK (Quadrature Phase Shift Keying) are used in a bundle.

### SUMMARY OF THE INVENTION

The present aims to provide a band-division demodulation method and an OFDM receiver capable of relieving the development costs of band-pass filters and being constructed economically by equalizing the characteristics of band-pass filters in the OFDM receiver performing parallel processing by band division.

The present is a band-division demodulation method in which the transmission band of a received RF signal is band-divided into a plurality, each band-divided signal is OFDM-demodulated, and the demodulation results are synthesized,

wherein the received RF signal is in-phase-distributed to a band division number, the band width that the entire band width of the received RF signal is divided by the band division number is used as a unit band width, each signal distributed so as to be shifted stepwise by integral times of the unit band width is frequency-converted, each signal frequency-converted is allowed to band-pass by filtering with the same characteristics to perform a band division, and the signal allowed to band-pass is OFDM-demodulated. Therefore, by equalizing the characteristics of band-pass filters for parallel processing by band division, the development costs of the band-pass filters can be relieved and it can be realized with an economical construction.

Besides, the present invention is an OFDM receiver in which the transmission band of a received RF signal is band-divided into a plurality, each band-divided signal is OFDM-demodulated, and the demodulation results are synthesized, comprising:

a distribution section for receiving an RF signal and in-phase-distributing it to a band division number; a frequency conversion section for using, as a unit band width, the band width that the entire band width of the received RF signal is divided by the band division number, and frequency-converting each signal distributed so as to be shifted stepwise by integral times of the unit band width; a band-pass filter section for allowing each signal frequency-converted to band-pass with the same characteristics; an OFDM demodulation section for OFDM-demodulating the signal allowed to band-pass; and a synthesizing section for synthesizing an output from the OFDM demodulation section to output demodulated data. Therefore, by equalizing the characteristics of band-pass filters for realizing parallel processing by band division, the development costs of the band-pass filters can be relieved and an economical construction can be realized.

### BRIEF DESCRIPTION OF THE DRAWINGS

FIG. 1 is a construction block diagram showing a first construction example of an OFDM receiver according to the present invention;

FIG. 2 is a block diagram showing an internal construction example of an OFDM demodulation section of the OFDM receiver of the present invention;

FIG. 3 is a chart showing frequency spectra of output signals from the respective parts in the OFDM receiver of the present invention;

FIG. 4 is a construction block diagram showing a second construction example of an OFDM receiver according to the present invention;

FIG. 5 is a construction block diagram showing a third construction example of an OFDM receiver according to the present invention.

### DESCRIPTION OF REFERENCE NUMERALS

100: antenna, 101: local oscillator, 103: AGC section, 105: frequency conversion section, 106, 106′: OFDM demodulation section, 201: in-phase distributor, 202: BPF (1), 206: local oscillator (3), 210: P/S section, 301: A/D converter, 302: digital quadrature demodulator, 303, 304: S/P section, 305, 306: DFT section, 307: decoding circuit, 401: local oscillator (7), 402: local oscillator (8), 403: local oscillator (9), 404: frequency conversion section, 501: local oscillator (10), 502: local oscillator (11), 503: local oscillator (12), 504: local oscillator (13).

### DETAILED DESCRIPTION OF THE PREFERRED EMBODIMENT

An embodiment of the present invention will be described with reference to drawings.

Incidentally, function realization means describe below may be any circuit or device if it is means capable of realizing the function. Besides, part or the whole of the function can be realized by software. Further, the function realization means may be realized by a plurality or circuits, and a plurality of function realization means may be realized by a single circuit.

In a band-division demodulation method according to the present invention, a received RF signal is in-phase-distributed to a band division number, the band width that the entire band width of the received RF signal is divided by the band division number is used as a unit band width, each signal distributed so as to be shifted stepwise by integral times of the unit band width is frequency-converted, each signal frequency-converted is allowed to band-pass by filtering with the same characteristics to perform a band division, and the signal allowed to band-pass is OFDM-demodulated. Therefore, by equalizing the characteristics of band-pass filters for realizing parallel processing by band division, the development costs of the band-pass filters can be relieved and it can be realized with an economical construction.

Besides, an OFDM receiver according to the present invention comprises a distribution section for receiving an RF signal and in-phase-distributing it to a band division number; a frequency conversion section for using, as a unit band width, the band width that the entire band width of the received RF signal is divided by the band division number, and frequency-converting each signal distributed so as to be shifted stepwise by integral times of the unit band width; a band-pass filter section for allowing each signal frequency-converted to band-pass with the same characteristics; an OFDM demodulation section for OFDM-demodulating the signal allowed to band-pass; and a synthesizing section for synthesizing an output from the OFDM demodulation section to output demodulated data. Therefore, by equalizing the characteristics of band-pass filters for realizing parallel processing by band division, the development costs of the band-pass filters can be relieved and an economical construction can be realized.

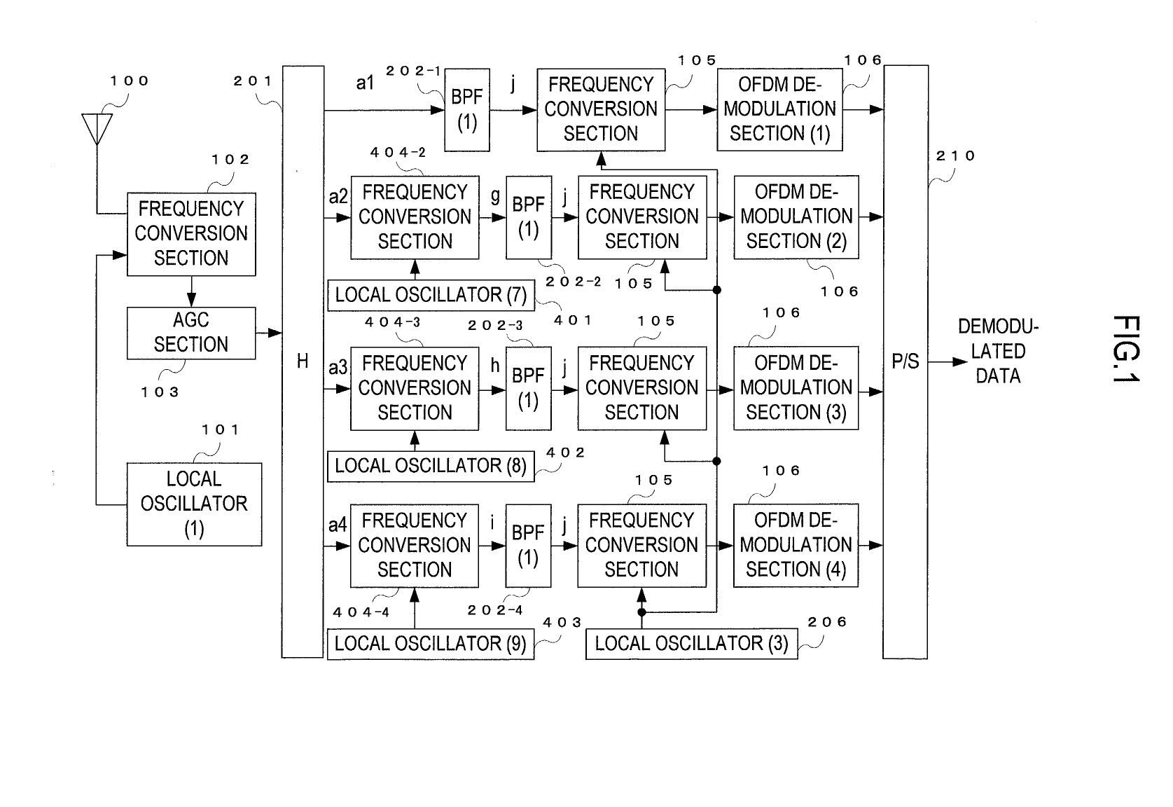

Incidentally, describing the correspondence between each means portion in an embodiment of the present invention and each part of FIG. 1, the distribution section corresponds to an antenna 100, a local oscillator (1) 101, a frequency conversion section 102, and an AGC section 103; the frequency conversion section corresponds to a local oscillator (7) 401, a local oscillator (8) 402, a local oscillator (9) 403, and a frequency conversion section 404; the band-pass filter section corresponds to BPF (1) 202-1 to 202-4; the OFDM demodulation section corresponds to a frequency conversion section 105, a local oscillator (3) 206, and an OFDM demodulation section 106; and the synthesizing section corresponds to a P/S section 210.

First, the first construction example of an OFDM receiver according to an embodiment of the present invention will be described with reference to FIG. 1. FIG. 1 is a construction block diagram showing the first construction example of the OFDM receiver according to the present invention. Note that FIG. 1 shows a construction example in case of band division into four parallel processes.

The first construction example of the OFDM receiver according to this embodiment (hereinafter referred to as the first OFDM receiver) is made up from, in addition to an antenna 100, a local oscillator (1) 101, a frequency conversion section 102, an AGC section 103, an in-phase distributor (H in FIG. 1) 201, a local oscillator (3) 206, a frequency conversion section 105 in each series, an OFDM demodulation section 106, and a P/S section (P/S in FIG. 1) 210, which are the same constructions as in the conventional OFDM receiver, a local oscillator (7) 401, a local oscillator (8) 402, a local oscillator (9) 403, a frequency conversion section 404-2 to 404-4 in each series, and BPF (1) 202-1 to 202-4, as characteristic parts of the present invention.

Each part of the first OFDM receiver of the present invention will be described.

The antenna 100 is an antenna for receiving RF (Radio Frequency) signals.

The local oscillator is a local oscillator for oscillating a first local frequency signal.

The frequency conversion section 102 is a frequency conversion section for multiplying a higher harmonic RF signal by the first local frequency signal to convert it into a first IF (Intermediate Frequency) frequency band. Here, the first IF frequency band is an intermediate frequency band possible or easy to realize by the specification in the subsequent AGC section 103, BPF (1) 202, and so on.

The AGC section 103 is an AGC (Automatic Gain Control) amplifier for amplifying or attenuating its input signal so that its output may always be at a desired constant power level.

The in-phase distributor is a distributor for distribution-output its input signal in phase into four series as a band division number.

The BPF (1) 202 is a band-pass filter whose center frequency is a first frequency fa, and in which, in case that the band width treated by the entire device is BW, a band limit is performed with a band width of BW/4. This BW/4 is a unit band width shown in claims. Note that the BPF (1) 202-1 to 202-4 disposed in each series are band-pass filters each having the above characteristics.

In the local oscillator (3) 206, when a second intermediate frequency after conversion by the frequency conversion section is f2, the oscillation frequency of the local oscillator (3) 206 corresponds to the center frequency of the BPF (1) 202 and is fa−f2.

The frequency conversion section 105 is a frequency conversion section for multiplying its input signal by the local frequency signal from the local oscillator (3) 206 to convert it into a second IF frequency band f2.

The OFDM demodulation section 106 is an OFDM demodulation section for OFDM-demodulating the second frequency band signal in each series.

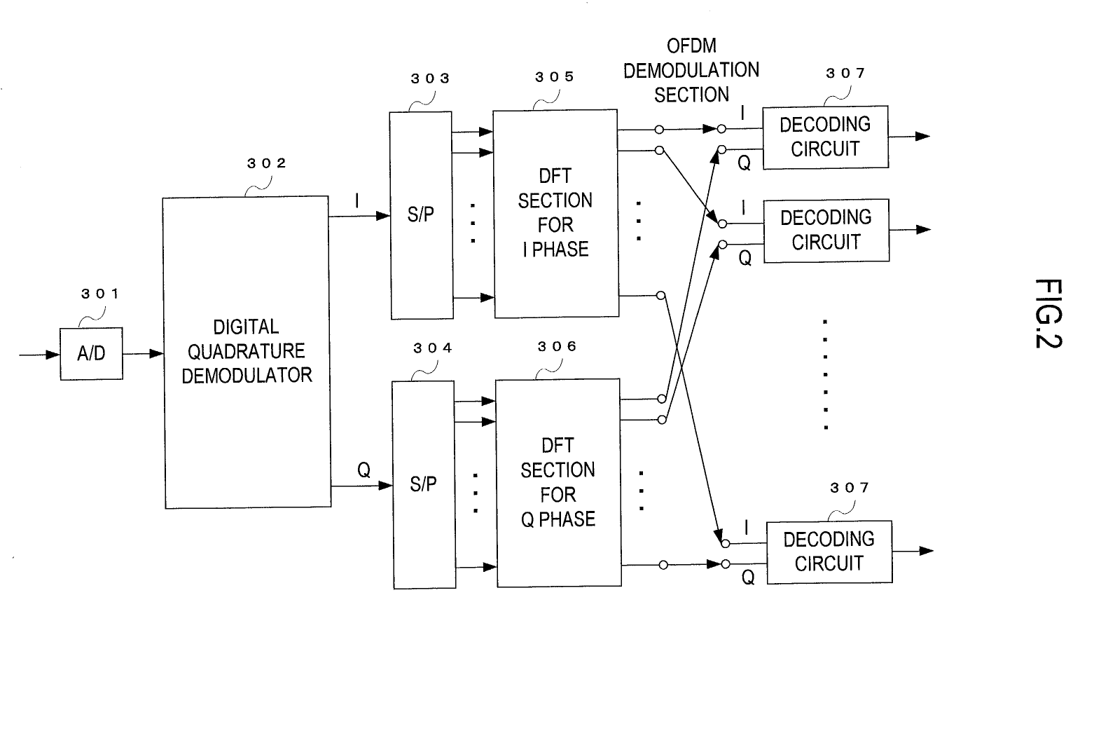

Here, an example of internal construction of the OFDM modulation section 106 will be described in brief with reference to FIG. 2. FIG. 2 is a block diagram showing an example of internal construction of the OFDM modulation section 106 of the OFDM receiver of the present invention.

The interior of the OFDM modulation section 106 of the OFDM receiver of the present invention is made up from an A/D converter 301 for converting the input signal into a digital signal; a digital quadrature demodulator 302 for quadrature-demodulating the digital signal into I and Q base band signals and outputting them; an S/P section 303 and an S/P section 304 for series-to-parallel-converting the I and Q base band signals, respectively; a DFT section 305 and a DFT section 306 for discrete-Fourier-transforming the I and Q signals output in parallel, respectively; and a decoding circuit 307 for decoding the I and Q signals at each timing and outputting decoded data.

As the operation of the OFDM modulation section 106 of the OFDM receiver of the present invention, an input signal is converted in the A/D converter 301 into a digital signal, and then quadrature-demodulated in the digital quadrature demodulator 302 into I and Q base band signals, and the respective signals are series-to-parallel-converted in the S/P section 303 and the S/P section 304, and then discrete-Fourier-transformed in the DFT section 305 and the DFT section 306, and the I and Q signals input are decoded in each decoding circuit 307 and decoded data is output.

The P/S section 210 is a parallel-to-series conversion section for converting the decoded data output in parallel from the OFDM demodulation section 106 in each series, and outputting it as demodulated data.

Hereinafter, parts provided as characteristic portions of the present invention will be described.

The local oscillator (7) 401 is an oscillator for outputting a local signal for shifting the output signal a from the in-phase distributor 201 by BW/4, which is one time the unit band width BW/4.

The local oscillator (8) 402 is an oscillator for outputting a local signal for shifting the output signal a from the in-phase distributor 201 by BW/2, which is double the unit band width BW/4.

The local oscillator (9) 403 is an oscillator for outputting a local signal for shifting the output signal a from the in-phase distributor 201 by 3BW/4, which is triple the unit band width BW/4.

The frequency conversion section 404-2 to 404-4 in each series is for multiplying the output signal a from the in-phase distributor 201 by the local signal from the local oscillator (7) 401, the local oscillator (8) 402, or the local oscillator (9) 403, thereby frequency-converting the output signal a into a signal whose frequency band has been shifted by BW/4, BW/2, or 3·bW/4, and outputting it.

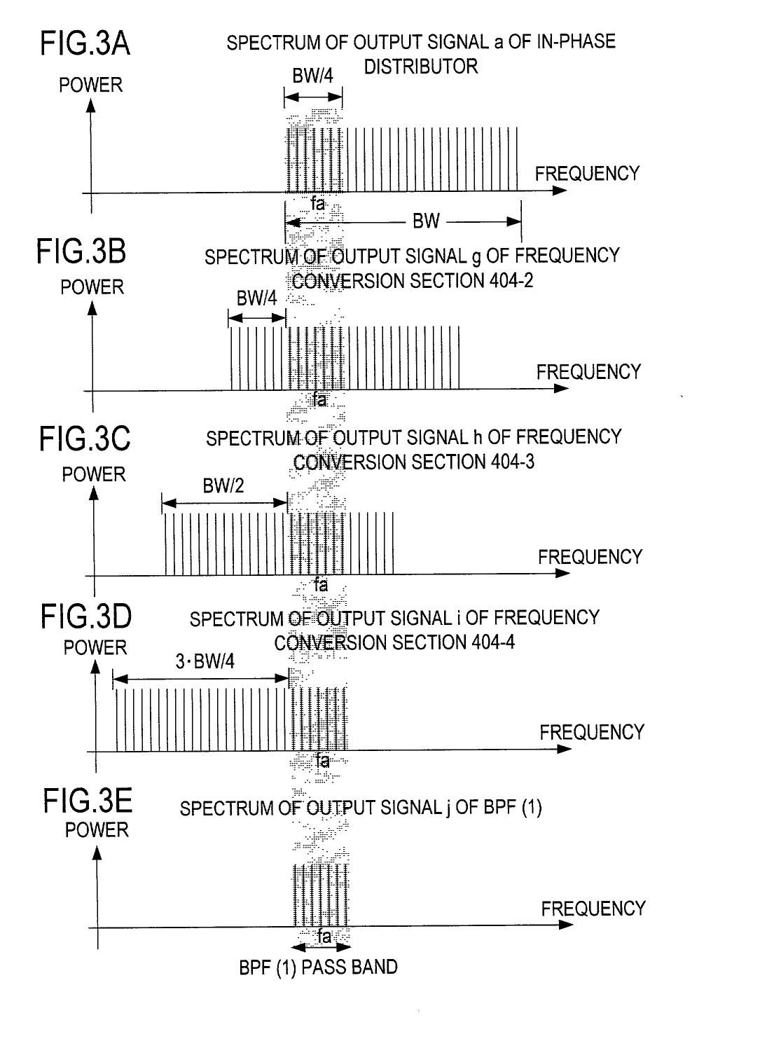

Next, the operation of the first OFDM receiver of the present invention will be described with reference to FIGS. 1 and 3. FIG. 3 is a chart showing frequency spectra of output signals from the respective parts in the OFDM receiver of the present invention.

As the operation of the first OFDM receiver of the present invention, a high-frequency RF signal is input through the antenna 100, converted in the frequency conversion section 102 into a first IF frequency band f1 as an intermediate frequency by being multiplied by the local frequency signal from the local oscillator (1) 101, amplified or attenuated in the AGC section 103 so as to be at a constant power level, and in-phase-distributed in the in-phase distributor 201 into four to output signals a1 to a4 to the respective series.

At this time, the frequency spectrum of the signal a output from the in-phase distributor 201 is shown in FIG. 3(a).

In the first series, the distributor output signal a1 is output to the BPF 1(202) without any change.

On the other hand, in the second series, the distributor output signal a2 is multiplied in the frequency conversion section 404-2 by the local frequency signal from the local oscillator (7) 401, and thereby frequency-converted into a signal g that has been shifted by BW/4 as shown in FIG. 3(b), and the signal g is output.

Also, in the third series, the distributor output signal a3 is multiplied in the frequency conversion section 404-3 by the local frequency signal from the local oscillator (8) 402, and thereby frequency-converted into a signal h that has been shifted by BW/2 as shown in FIG. 3(c), and the signal h is output. In the fourth series, the distributor output signal a4 is multiplied in the frequency conversion section 404-4 by the local frequency signal from the local oscillator (9) 403, and thereby frequency-converted into a signal i that has been shifted by 3·BW/4 as shown in FIG. 3(d), and the signal i is output.

In each series, the in-phase distributor output a1 or the frequency-converted signals g, h, or i is filtered in the BPF (1) 202-1 to 202-4 with the center frequency fa and the band width BW/4, and output, and thereby a signal j of a band width shown in FIG. 3(e) is output. This corresponds to a frequency band that each frequency-converted signal has in common, as described in claims.

Here, although all of the signals filtered in the BPF (1) 202-1 to 202-4 are signals of the center frequency fa and the band width BW/4, since they are signals that has been shifted by BW/4 or its multiple, actually, it is found from the shaded portion of FIG. 3 that they are signals at the respective frequency position that the in-phase distributor output a is band-divided into four.

In each series, the output signal j from each BPF is multiplied in each frequency conversion section 105 by the local frequency signal from the local oscillator (3) 206, and thereby converted into a second IF frequency band f2 as a lowered frequency, output to each OFDM demodulation section 106, demodulated after quadrature demodulation in each OFDM demodulation section 106, parallel-to-series-converted in the P/S section 210, and then output as demodulated data.

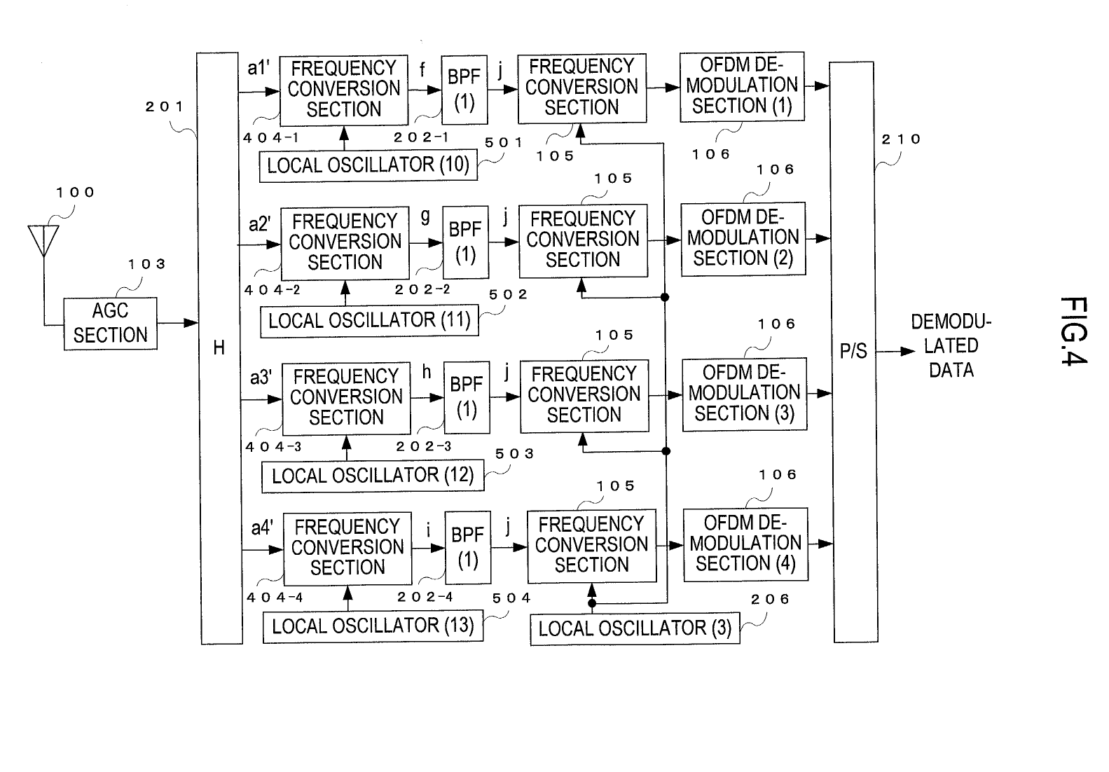

Next, another construction example (the second construction example) of the OFDM receiver according to the embodiment of the present invention will be described with reference to FIG. 4. FIG. 4 is a construction block diagram showing the second construction example of the OFDM receiver according to the present invention. Note that FIG. 4 shows a construction example of band division into four parallel processes. Parts taking the same constructions as in FIG. 1 will be described with being denoted by the same reference numerals.

The second construction example of the OFDM receiver according to this embodiment (hereinafter referred to as the second OFDM receiver) is made up from, in addition to an antenna 100, an AGC section 103, an in-phase distributor 201, a local oscillator (3) 206, a frequency conversion section 105 in each series, an OFDM demodulation section 106, and a P/S section 210, which are the same constructions as in the first OFDM receiver, a local oscillator (10) 501, a local oscillator (11) 502, a local oscillator (12) 503, a local oscillator (13) 504, a frequency conversion section 404-1 to 404-4 in each series, and BPF (1) 202-1 to 202-4, as characteristic parts of the present invention.

Here, in the first OFDM receiver, the frequency conversion into the first IF frequency band is once performed by the operations of the local oscillator (1) 101 and the frequency conversion section 102, and then the frequency band is shifted by the operations of the local oscillator (7) 401, the local oscillator (8) 402, the local oscillator (9) 403, and the frequency conversion sections 404-2 to 404-4 in each series. But, in the second OFDM receiver shown in FIG. 4, by the operations of the local oscillator (10) 501 to the local oscillator (13) 504 and the frequency conversion sections 404-1 to 404-4 in each series, while the frequency conversion into the first IF frequency band is performed, the frequency band is further shifted. This point is a point different from the first OFDM receiver.

Therefore, the oscillation frequency of the local oscillator (10) 501 in the first series shown in FIG. 4 may be considered to be the same as that of the local oscillator (1) 101 of the first OFDM receiver shown in FIG. 1.

As the operation of the second OFDM receiver of the present invention, a high-frequency RF signal is input through the antenna 100, amplified or attenuated in the AGC section 103 so as to be at a constant power level, and in-phase-distributed in the in-phase distributor 201 into four to output signals a1′ to a4′ to the respective series.

In the first series, the distributor output signal a1′ is multiplied in the frequency conversion section 404-1 by the local frequency signal from the local oscillator (10) 501, and thereby converted into a first IF frequency band as an intermediate frequency, and a signal f is output.

On the other hand, in the second series, the distributor output signal a2′ is multiplied in the frequency conversion section 404-2 by the local frequency signal from the local oscillator (11) 502, and thereby converted into the first IF frequency band as the intermediate frequency and further frequency-converted into a signal g that has been shifted by BW/4, and the signal g is output.

Also, in the third series, the distributor output signal a3′ is multiplied in the frequency conversion section 404-3 by the local frequency signal from the local oscillator (12) 503, and thereby converted into the first IF frequency band as the intermediate frequency and further frequency-converted into a signal h that has been shifted by BW/2, and the signal h is output. In the fourth series, the distributor output signal a4′ is multiplied in the frequency conversion section 404-4 by the local frequency signal from the local oscillator (13) 504, and thereby converted into the first IF frequency band as the intermediate frequency and further frequency-converted into a signal i that has been shifted by 3BW/4, and the signal i is output.

In each series, the frequency-converted signals f, h, or i is filtered in the BPF (1) 202-1 to 202-4 with the center frequency fa and the band width BW/4, and output, and thereby a signal j of a band width shown in FIG. 3(e) is output like the first OFDM receiver.

The subsequent operation is the same as in the first OFDM receiver.

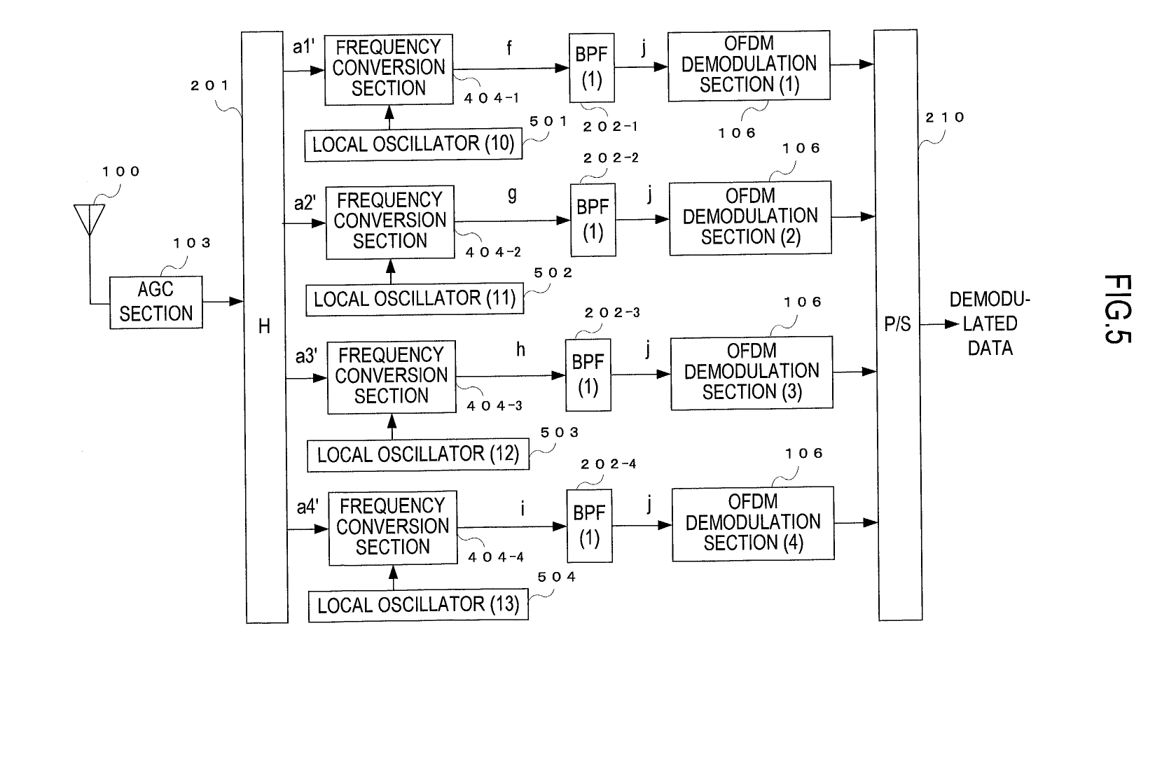

Next, another construction example (the third construction example) as an application of the above-described second OFDM receiver will be described with reference to FIG. 5. FIG. 5 is a construction block diagram showing the third construction example of the OFDM receiver according to the present invention. Note that FIG. 5 shows a construction example of band division into four parallel processes. Parts taking the same constructions as in FIG. 4 will be described with being denoted by the same reference numerals.

The third construction example of the OFDM receiver according to this embodiment (hereinafter referred to as the third OFDM receiver) is made up from an antenna 100, an AGC section 103, an in-phase distributor 201, a P/S section 210, and a local oscillator (10) 501, a local oscillator (11) 502, a local oscillator (12) 503, a local oscillator (13) 504 in each series, a frequency conversion sections 404-1 to 404-4, BPF (1) 202-1 to 202-4, and OFDM demodulation sections 106′, which are the same constructions as in the second OFDM receiver.

Here, in the second OFDM receiver shown in FIG. 4, after being band-limited in the BPF (1) 202 in each series, in order to cope with the A/D conversion performed at a high speed in the OFDM demodulation section 106, by the operations of the local oscillator (3) 206 and the frequency conversion section 105, the frequency conversion into the second IF frequency band as a lowered frequency is performed. But, in the third OFDM receiver shown in FIG. 5, without lowering the frequency to the second IF frequency band, the first IF frequency band is input to the OFDM demodulation sections 106 without any change.

Therefore, in the OFDM demodulation sections 106′ of the third OFDM receiver, although the construction is the construction shown in FIG. 2, as the specification of digital conversion in the A/D converter 301, by performing a so-called under-sampling operation in which the operation is performed at a frequency lower than the sampling clock for the second IF frequency band used in the second OFDM receiver, and at a sampling clock to correspond to the first IF frequency band, the input IF signal without being changed from the first IF frequency band is directly converted into a base band digital signal.

As a result of the under-sampling operation by this low frequency, a digital signal that has been frequency-converted to the vicinity of 0 Hz on the frequency axis is output, and the target signal that has been frequency-converted to the vicinity of 0 Hz on the frequency axis is input to the subsequent digital quadrature demodulator 302 and digital-quadrature-demodulated, and converted into the base band signal of each of I and Q.

Note that the construction shown in FIG. 5 is a construction in which, in the second OFDM receiver shown in FIG. 4, the local oscillator (3) 206 and the frequency conversion section 105 for conversion into the second IF frequency band are eliminated. But, the same construction is thinkable also in the first OFDM receiver shown in FIG. 1.

As the operation of the third OFDM receiver of the present invention, a high-frequency RF signal is input through the antenna 100, amplified or attenuated in the AGC section 103 so as to be at a constant power level, and in-phase-distributed in the in-phase distributor 201 into four to output signals a1′ to a4′ to the respective series.

In the first series, the distributor output signal a1′ is multiplied in the frequency conversion section 404-1 by the local frequency signal from the local oscillator (10) 501, and thereby converted into a first IF frequency band as an intermediate frequency, and a signal f is output.

On the other hand, in the second series, the distributor output signal a2′ is multiplied in the frequency conversion section 404-2 by the local frequency signal from the local oscillator (11) 502, and thereby converted into the first IF frequency band as the intermediate frequency and further frequency-converted into a signal g that has been shifted by BW/4, and the signal g is output.

Also, in the third series, the distributor output signal a3′ is multiplied in the frequency conversion section 404-3 by the local frequency signal from the local oscillator (12) 503, and thereby converted into the first IF frequency band as the intermediate frequency and further frequency-converted into a signal h that has been shifted by BW/2, and the signal h is output. In the fourth series, the distributor output signal a4′ is multiplied in the frequency conversion section 404-4 by the local frequency signal from the local oscillator (13) 504, and thereby converted into the first IF frequency band as the intermediate frequency and further frequency-converted into a signal i that has been shifted by 3BW/4, and the signal i is output.

In each series, the frequency-converted signals f, g, h, or i is filtered in the BPF (1) 202-1 to 202-4 with the center frequency fa and the band width BW/4, and output, and thereby a signal j of a band width shown in FIG. 3(e) is extracted and output like the first OFDM receiver, and then input to each OFDM demodulation sections 106′.

In each OFDM demodulation sections 106′, a digital signal that has been under-sampled in the A/D converter 301′ by a frequency lower than the IF frequency of the input signal and frequency-converted to the vicinity of 0 Hz on the frequency axis is output, digital-quadrature-demodulated in the digital quadrature demodulator 302, and converted into a bas band signal of each of I and Q. After this, each of I and Q is series-to-parallel-converted in the S/P section 303 or S/P section 304, and DFT-converted in the DFT section 305 or DFT section 306, and I or Q signal is decoded in each decoding circuit 307, and finally parallel-to-series-converted in the P/S section 210 to output demodulated data.

According to the OFDM reception demodulation method and the OFDM receiver according to the embodiment of the present invention, band division is realized by, after a received signal is in-phase-distributed in the distribution section by the band division number and each distributed signal is shifted stepwise by the band width in accordance with the band division number, performing filtering with band-pass filters of one kind having the same center frequency and band width, and each signal is OFDM-demodulated. Therefore, the band-pass filters for realizing the band division can be constructed by one kind of the same characteristics, and there is an effect that the development costs of the band-pass filter can be relieved and an economical construction is possible.

According to the first OFDM receiver according to the embodiment of the present invention, band division is realized by, after a received signal is in-phase-distributed in the in-phase distributor 201 by the band division number and each distributed signal is shifted stepwise by the band width in accordance with the band division number by the operations of the local oscillator (7) 401 to the local oscillator (9) 403 and the frequency conversion sections 404-2 to 4, performing filtering with band-pass filters (BPF (1) 202) of one kind having the same center frequency and band width (the same characteristics), and each signal is OFDM-demodulated in the OFDM demodulation section. Therefore, by the frequency conversion in which the received signal is shifted by the band width in accordance with the band division number, it can be realized by filtering with band-pass filters of one kind, and there is an effect that there is no requirement of developing band-pass filters having different characteristics corresponding to the band division number, thus the development costs of the band-pass filter can be relieved and an economical construction is possible.

According to the second FDM receiver according to the embodiment of the present invention, band division is realized by, after a received signal is in-phase-distributed in the in-phase distributor 201 by the band division number and each distributed signal is shifted stepwise by the band width in accordance with the band division number while being lowered to the first IF frequency band by the operations of the local oscillator (10) 501 to the local oscillator (13) 504 and the frequency conversion sections 404-1 to 4, performing filtering with band-pass filters (BPF (1) 202) of one kind having the same center frequency and band width (the same characteristics), and each signal is OFDM-demodulated in the OFDM demodulation section. Therefore, by the frequency conversion in which the received signal is shifted by the band width in accordance with the band division number, it can be realized by filtering with band-pass filters of one kind, and there is an effect that there is no requirement of developing band-pass filters having different characteristics corresponding to the band division number, thus the development costs of the band-pass filter can be relieved and an economical construction is possible.

Besides, according to the first OFDM receiver and the second OFDM receiver, by performing frequency conversion so that each signal distributed by the operations of the local oscillators (7) 401 to 403 or the local oscillators (10) 501 to 504 and the frequency conversion section 404 is shifted by the unit band width that the entire band width is divided by the band division number, and band-passing the BPF (1) 202 of the same characteristics, the signal after band-passing is made into a signal of the same frequency band. Therefore, the local oscillator (the local oscillator (2) 206) for the second IF can be made in common in each series, and there is an effect that the hardware magnitude can be reduced.

Besides, by restricting the kinds of BPF (1) 202 to one kind, the characteristic variation of the BPF is reduced and it becomes a construction that works superiorly for the reception of an OFDM wave sensitive to quadrature.

Besides, according to the third FDM receiver according to the embodiment of the present invention, after the conversion into the first IF frequency band and the frequency conversion for band division by the operations of the local oscillator (10) 501 to the local oscillator (13) 504 and the frequency conversion section 404 and performing band limitation by the BPF (1) 202, by inputting to the OFDM demodulation section 106 without any change without lowering to the second IF frequency band signal, and utilizing an under-sampling technique in the A/D converter 301, there is not only an effect that the development of one kind of band-pass filter (BPF (1) 202) suffices, but also an effect that the circuit magnitude of the radio section in the receiver for receiving and demodulating the OFDM signal can be considerably relieved, and a size reduction and a cost reduction can be intended.

According to the present invention, because of the band-division demodulation method wherein the received RF signal is in-phase-distributed to a band division number, the band width that the entire band width of the received RF signal is divided by the band division number is used as a unit band width, each signal distributed so as to be shifted stepwise by integral times of the unit band width is frequency-converted, each signal frequency-converted is allowed to band-pass by filtering with the same characteristics to perform a band division, and the signal allowed to band-pass is OFDM-demodulated, by equalizing the characteristics of band-pass filters for parallel processing by band division, there is an effect that the development costs of the band-pass filters can be relieved and it can be realized with an economical construction.

According to the present invention, because of the OFDM receiver wherein a distribution section receives an RF signal and in-phase-distributing it to a band division number,; the band width that the entire band width of the received RF signal is divided by the band division number is used as a unit band width, each signal distributed so as to be shifted stepwise by integral times of the unit band width is frequency-converted, a band-pass filter section allows each signal frequency-converted to band-pass with the same characteristics, an OFDM demodulation section OFDM-demodulates the signal allowed to band-pass, and a synthesizing section synthesizes an output from the OFDM demodulation section to output demodulated data, by equalizing the characteristics of band-pass filters for parallel processing by band division, there is an effect that the development costs of the band-pass filters can be relieved and it can be realized with an economical construction.

What is claimed is:

1. A band-division demodulation method in which a transmission band of a received RF signal is band-divided into a plurality, each of signals said band-divided is OFDM-demodulated, and said demodulation results are synthesized,
wherein the received RF signal is in-phase-distributed to said band division number, the band width that the entire band width of said received RF signal is divided by said band division number is used as a unit band width, each signal said distributed so as to be shifted stepwise by integral times of said unit band width is frequency-converted, each signal said frequency-converted is allowed to band-pass by filtering with the same characteristics to perform a band division, and said signal allowed to band-pass is OFDM-demodulated.

2. An OFDM receiver in which a transmission band of a received RF signal is band-divided into a plurality, each of signals said band-divided is OFDM-demodulated, and said demodulation results are synthesized, comprising:
a distribution section for receiving an RF signal and in-phase-distributing it to said band division number;
a frequency conversion section for using, as a unit band width, the band width that the entire band width of said received RF signal is divided by said band division number, and frequency-converting each signal said distributed so as to be shifted stepwise by integral times of said unit band width;
a band-pass filter section for allowing each signal said frequency-converted to band-pass with the same characteristics;
an OFDM demodulation section for OFDM-demodulating said signal allowed to band-pass; and
a synthesizing section for synthesizing an output from said OFDM demodulation section to output demodulated data.

3. The OFDM receiver according to claim 2, wherein said band-pass filter section is a band-pass filter section of the same characteristics for allowing a frequency band that each signal said frequency-converted has in common.

4. An OFDM receiver in which a transmission band of a received RF signal is band-divided into a plurality, each of signals said band-divided is OFDM-demodulated, and said demodulation results are synthesized, comprising:
a first frequency conversion section for receiving an RF signal and converting it into a first IF frequency band;
an AGC section for adjusting an output signal from said first frequency conversion section to a certain constant output level and outputting it;
an in-phase distributor for in-phase-distributing an output from said AGC section into said band width division number;
a second frequency conversion section for using, as a unit band width, the band width that the entire band width of said received RF signal is divided by said band division number, and frequency-converting each output from said in-phase distributor so as to be shifted stepwise by integral times of said unit band width;
a band-pass filter section for allowing each signal said frequency-converted to band-pass with the same characteristics;
a third frequency conversion section for frequency-converting said each band-pass signal into a second IF frequency band;
an OFDM demodulation section for OFDM-demodulating an output from said third frequency conversion section; and
a P/S section for parallel-to-series-converting and synthesizing an output from said each OFDM demodulation section.

5. An OFDM receiver in which a transmission band of a received RF signal is band-divided into a plurality, each of signals said band-divided is OFDM-demodulated, and said demodulation results are synthesized, comprising:
an AGC section for receiving an RF signal, adjusting it to a certain constant output level, and outputting it;
an in-phase distributor for in-phase-distributing an output from said AGC section into said band width division number;
a fourth frequency conversion section for frequency-converting each output from said in-phase distributor, using, as a unit band width, the band width that the entire band width of said received RF signal is divided by said band division number, and frequency-converting each output from said in-phase distributor so as to be shifted stepwise by integral times of said unit band width;
a band-pass filter section for allowing each signal said frequency-converted to band-pass with the same characteristics;
a fifth frequency conversion section for frequency-converting said each band-pass signal into a second IF frequency band;
an OFDM demodulation section for OFDM-demodulating an output from said fifth frequency conversion section; and
a P/S section for parallel-to-series-converting and synthesizing an output from said each OFDM demodulation section.

6. An OFDM receiver in which a transmission band of a received RF signal is band-divided into a plurality, each of signals said band-divided is OFDM-demodulated, and said demodulation results are synthesized, comprising:
an AGC section for receiving an RF signal, adjusting it to a certain constant output level, and outputting it;
an in-phase distributor for in-phase-distributing an output from said AGC section into said band width division number;
a fourth frequency conversion section for frequency-converting each output from said in-phase distributor, using, as a unit band width, the band width that the entire band width of said received RF signal is divided by said band division number, and frequency-converting each output from said in-phase distributor so as to be shifted stepwise by integral times of said unit band width;
a band-pass filter section for allowing each signal said frequency-converted to band-pass with the same characteristics;
an OFDM demodulation section for inputting an output from said band-pass filter section, under-sampling it by a frequency lower than a usual sampling frequency in accordance with the frequency of said input signal to convert it into a digital signal, and OFDM-demodulating it; and
a P/S section for parallel-to-series-converting and synthesizing an output from said each OFDM demodulation section.

7. A multi-carrier transmission system having a transmitter for OFDM-modulating and transmitting a transmission signal, and a receiver for receiving and OFDM-demodulating said radio transmission signal,
wherein said receiver is the OFDM receiver according to claim 2.

8. A multi-carrier transmission system having a transmitter for OFDM-modulating and transmitting a transmission signal, and a receiver for receiving and OFDM-demodulating said radio transmission signal,
wherein said receiver is the OFDM receiver according to claim 3.

9. A multi-carrier transmission system having a transmitter for OFDM-modulating and transmitting a transmission signal, and a receiver for receiving and OFDM-demodulating said radio transmission signal,
wherein said receiver is the OFDM receiver according to claim 4.

10. A multi-carrier transmission system having a transmitter for OFDM-modulating and transmitting a transmission signal, and a receiver for receiving and OFDM-demodulating said radio transmission signal,
wherein said receiver is the OFDM receiver according to claim 5.

11. A multi-carrier transmission system having a transmitter for OFDM-modulating and transmitting a transmission signal, and a receiver for receiving and OFDM-demodulating said radio transmission signal,
wherein said receiver is the OFDM receiver according to claim 6.

12. A multi-carrier transmission system having a transmitter for OFDM-modulating and transmitting a transmission signal, and a receiver for receiving and OFDM-demodulating said radio transmission signal,
wherein said receiver is the OFDM receiver according to claim 7.
